(19) United States
(12) Patent Application Publication
(10) Pub. No.: US 2011/0228190 A1
(43) Pub. Date: Sep. 22, 2011

(54) CURVED DISPLAY PANEL

(75) Inventors: Wei-Chieh Yang, Taipei City (TW); Wei-Yi Chien, Keelung City (TW); Maw-Song Chen, Taipei City (TW)

(73) Assignee: AU OPTRONICS CORPORATION, Hsinchu (TW)

(21) Appl. No.: 12/817,220

(22) Filed: Jun. 17, 2010

(30) Foreign Application Priority Data
Mar. 22, 2010 (TW) 99108354

(51) Int. Cl. G02F 1/1333

(52) U.S. Cl. 349/56

(57) ABSTRACT

A curved display panel includes a first substrate, a second substrate, a display medium, spacers, and padding-islands. The second substrate has a first surface and a second surface opposite to the first surface. The first surface faces toward the first substrate, and the second surface faces against the first substrate. The display medium and the spacers are disposed between the first and the second substrates. The padding-islands are disposed on a plurality of regions of the first surface of the second substrate. The padding-islands on the different regions have different thicknesses. Another curved display panel includes two substrates, a display medium, and spacing pillars. The display medium and the spacing pillars are disposed between the substrates. Bottom areas of the spacing pillars decrease from the center to the outside of the substrates along at least one first direction. Cross-sections of the substrates along the first direction are curved.

### CROSS-REFERENCE TO RELATED APPLICATION

This application claims the priority benefit of Taiwan application serial no. 99108354, filed on Mar. 22, 2010. The entirety of the above-mentioned patent application is hereby incorporated by reference herein and made a part of this specification.

### BACKGROUND OF THE INVENTION

1. Field of the Invention

The invention relates to a display panel. More particularly, the invention relates to a curved display panel.

2. Description of Related Art

Progress in science and technology leads to continuing development of display technology. Flat panel displays (FPDs) which are small and compact have gradually replaced conventional cathode ray tube (CRT) displays. Moreover, the FPDs characterized by compactness are currently disposed on non-planar surfaces of buildings or electronic equipment.

FIG. 1 is a schematic cross-sectional view illustrating a conventional curved liquid crystal display (LCD) panel. As indicated in FIG. 1, in a conventional curved LCD panel 100, a liquid crystal layer 120 is sandwiched between two planar glass substrates 110, and the two glass substrates 110 and the liquid crystal layer 120 are fixed by a curved iron frame (not shown), such that the LCD panel 100 is curved. However, the force exerted on the two glass substrates 110 by the iron frame is not uniform, and the stress at edges of the glass substrates 110 and the stress at the centers of the glass substrates 110 are different. Accordingly, in the curved LCD panel 100, a distance between the centers of the two glass substrates 110 is often shorter than a distance between the edges of the two glass substrates 110. Thereby, the curved LCD panel 100 cannot normally perform the display function.

FIG. 2 is a schematic cross-sectional view illustrating another conventional curved LCD panel. With reference to FIG. 2, the distance between the two glass substrates 210 is not constant in the conventional curved LCD panel 200 as that in the curved LCD panel 100. Nevertheless, the curved LCD panel 200 is further equipped with the touch-sensing function. The touch-sensing function is accomplished by a plurality of pressure sensors 230 disposed in the curved LCD panel 200. When a user presses the curved LCD panel 200, sensing pillars 240 in the curved LCD panel 200 touch the pressure sensors 230 in a downward manner, such that the pressure sensors 230 are triggered to perform the touch-sensing function. However, if the distance between the centers of the two glass substrates 210 in the curved LCD panel 200 is overly short, the sensing pillars 240 in the curved LCD panel 200 constantly touch and trigger the pressure sensors 230. As such, the curved LCD panel 200 is not allowed to achieve the touch-sensing function.

### SUMMARY OF THE INVENTION

The invention is directed to a curved display panel capable of resolving an issue of non-uniform distance between substrates.

In the invention, a curved display panel including a first substrate, a second substrate, a display medium, a plurality of first spacers, and a plurality of padding-islands is provided. The second substrate has a first surface and a second surface opposite to the first surface. The first surface faces toward the first substrate, and the second surface faces against the first substrate. The display medium and the first spacers are disposed between the first and the second substrates. The padding-islands are disposed on a plurality of regions of the first surface of the second substrate. The padding-islands on the different regions have different thicknesses.

In the invention, another curved display panel including a first substrate, a second substrate, a display medium, and a plurality of first spacers is provided. The display medium and the first spacers are disposed between the first and the second substrates. Bottom areas of the first spacers decrease from the center of the second substrate to the outside of the second substrate along at least one first direction. A cross-section of the second substrate along the first direction is curved.

Based on the above, in the curved display panel of this invention, the distance between the substrates remains constant by adjusting the thicknesses of the padding-islands on the different regions or by changing the bottom areas of the spacers. Thereby, display quality can be improved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a conventional curved LCD panel.

FIG. 2 is a schematic cross-sectional view illustrating another conventional curved LCD panel.

FIG. 3A and FIG. 3B are schematic views respectively illustrating a curved display panel according to an embodiment of the invention when the curved display panel is in a planar state and in a curved state.

FIG. 4 is a schematic view illustrating a curved display panel according to another embodiment of the invention.

FIG. 5 is a schematic view illustrating a curved display panel according to still another embodiment of the invention.

FIG. 6 is a schematic view illustrating a curved display panel according to still another embodiment of the invention.

FIG. 7 is a schematic view illustrating a curved display panel according to still another embodiment of the invention.

FIG. 8 is a schematic view illustrating a curved display panel according to still another embodiment of the invention.

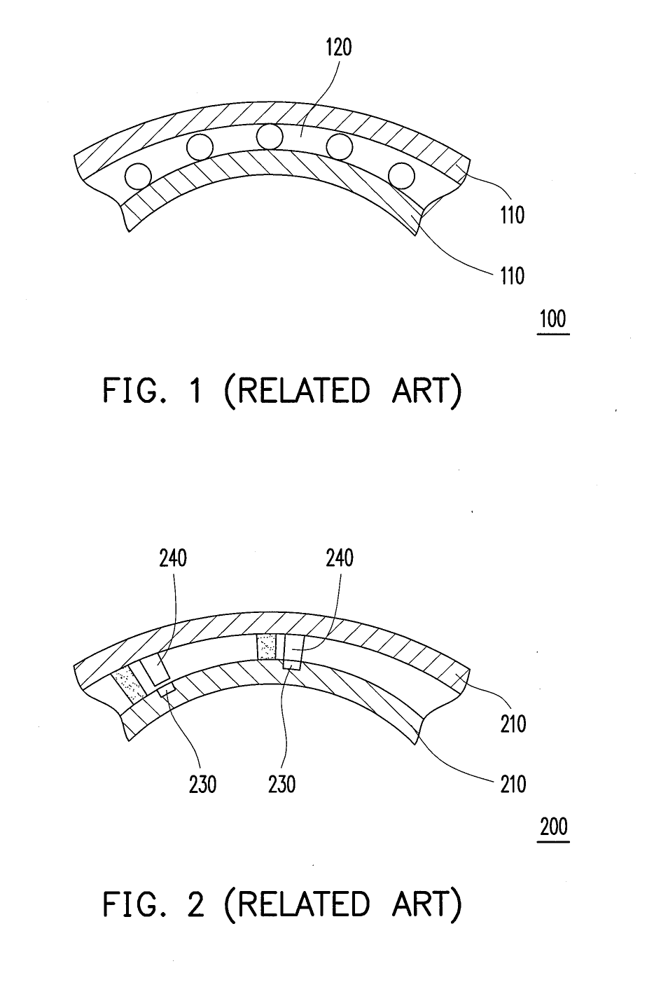

### DESCRIPTION OF EMBODIMENTS

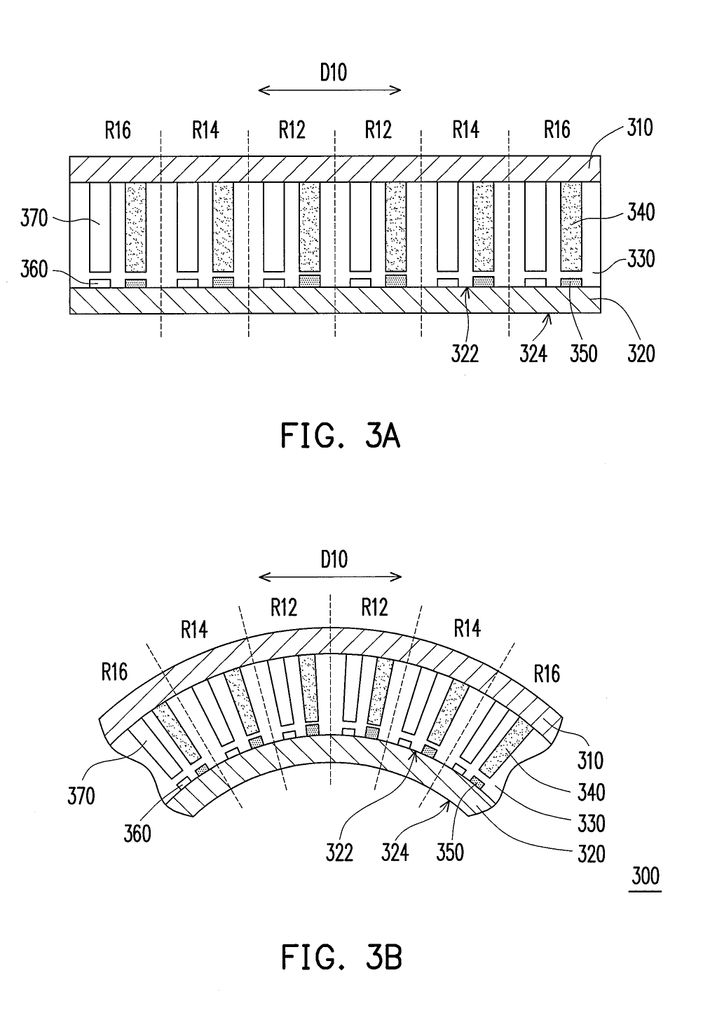

FIG. 3A and FIG. 3B are schematic views respectively illustrating a curved display panel according to an embodiment of the invention when the curved display panel is in a planar state and in a curved state. As shown in FIG. 3A and FIG. 3B, a curved display panel 300 of this embodiment includes a first substrate 310, a second substrate 320, a display medium 330, a plurality of first spacers 340, and a plurality of padding-islands 350. The second substrate 320 has a first surface 322 and a second surface 324 opposite to the first surface 322. The first surface 322 faces toward the first substrate 310, and the second surface 324 faces against the first substrate 310. The display medium 330 and the first spacers 340 are disposed between the first substrate 310 and the second substrate 320. The padding-islands 350 are disposed on a plurality of regions R12, R14, and R16 of the first surface 322 of the second substrate 320. The padding-islands 350 on the different regions have different thicknesses. When the curved display panel 300 is being formed, each component of the curved display panel 300 is assembled (as shown in FIG. 3A) in a planar manner, and the curved display panel 300 is bent, such that the curved display panel 300 is in a curved state (as shown in FIG. 3B).

Distribution of stresses on the different regions of the second substrate 320 can be adjusted by means of the padding-islands 350 having the different thicknesses. Thereby, the regions R12 at the center of the second substrate 320 and the regions R16 at the peripheries of the second substrate 320 can be bent to similar degrees, such that a distance between the first substrate 310 and the second substrate 320 remains constant. In case of uniformity of the distance between the first substrate 310 and the second substrate 320, display quality of the curved display panel 300 is optimized.

The second surface 324 is a concave surface in this embodiment. Besides, the thicknesses of the padding-islands 350 on the different regions decrease from the center of the second substrate 320 to the outside of the second substrate 320 along at least one direction D10. A cross-section of the second substrate 320 along the direction D10 is curved. Specifically, the thicknesses of the padding-islands 350 on the regions R12 are greater than the thicknesses of the padding-islands 350 on the regions R14, and the thicknesses of the padding-islands 350 on the regions R14 are greater than the thicknesses of the padding-islands 350 on the regions R16. In this embodiment, each of the padding-islands 350 is disposed in one of the regions R12, R14, and R16, for example. However, more padding-islands 350 can be disposed in each of the regions R12, R14, and R16 according to other embodiments, and the thicknesses of the padding-islands 350 in each of the regions R12, R14, and R16 can be the same, so as to simplify the manufacturing process of the curved display panel 300. A material of the padding-islands 350, for instance, is photoresist, enzocyclobutane (BCB), cycloolefin, polyimide, polyamide, polyester, polyalcohols, polyethylene, polyphenylene, resin, polyether, polyketone, or any other organic material. The “island” herein means that the padding-islands 350 are not entirely formed on the second substrate 320 but individually disposed on the second substrate 320.

The curved display panel 300 of this embodiment can further includes a plurality of sensing pads 360 and a plurality of sensing pillars 370. The sensing pads 360 are disposed on the first surface 322 of the second substrate 320, and the sensing pillars 370 are disposed on the first substrate 310 for correspondingly pressing the sensing pads 360. When a user presses the curved LCD panel 300, the sensing pillars 370 in the curved LCD panel 300 touch the sensing pads 360 in a downward manner, such that the sensing pads 360 are triggered to perform the touch-sensing function. Since the distance between the first and the second substrates 310 and 320 remains constant, the sensing pillars 370 do not constantly touch and trigger the sensing pads 360. As such, the curved LCD panel 300 is allowed to achieve the touch-sensing function. The sensing pads 360 can be pressure sensors or other types of sensing pads. Certainly, locations of the sensing pillars 370 and those of the sensing pads 360 can be exchanged. That is to say, the sensing pillars 370 are disposed on the second substrate 320, and the sensing pads 360 are disposed on the first substrate 310.

The second substrate 320 of this embodiment is an active device array substrate, and the first substrate 310 is a color filter substrate. In other embodiments, the second substrate 320 can be the color filter substrate, and the first substrate 310 can be the active device array substrate. In an alternative, the color filter film and the active device array can be formed on the same substrate. On the other hand, when the curved display panel 300 is observed from the top of FIG. 3A, the regions R12, R14, and R16 of the second substrate 320 can have a stripe shape, a grid shape, or any other shape. The display medium 330 can be liquid crystal. In this embodiment, the thicknesses of the padding-islands 350 vary along the direction D10, while the thickness of the padding-islands 350 can vary along other directions as well when the curved display panel 300 is in a spherical state or in a different curved state. The curved display panel 300 can be bent once or bent in a wavy manner, and the thicknesses of the padding-islands 350 are determined based on whether the locations of the padding-islands 350 are close to the wave peaks and the wave troughs or close to the inflection points.

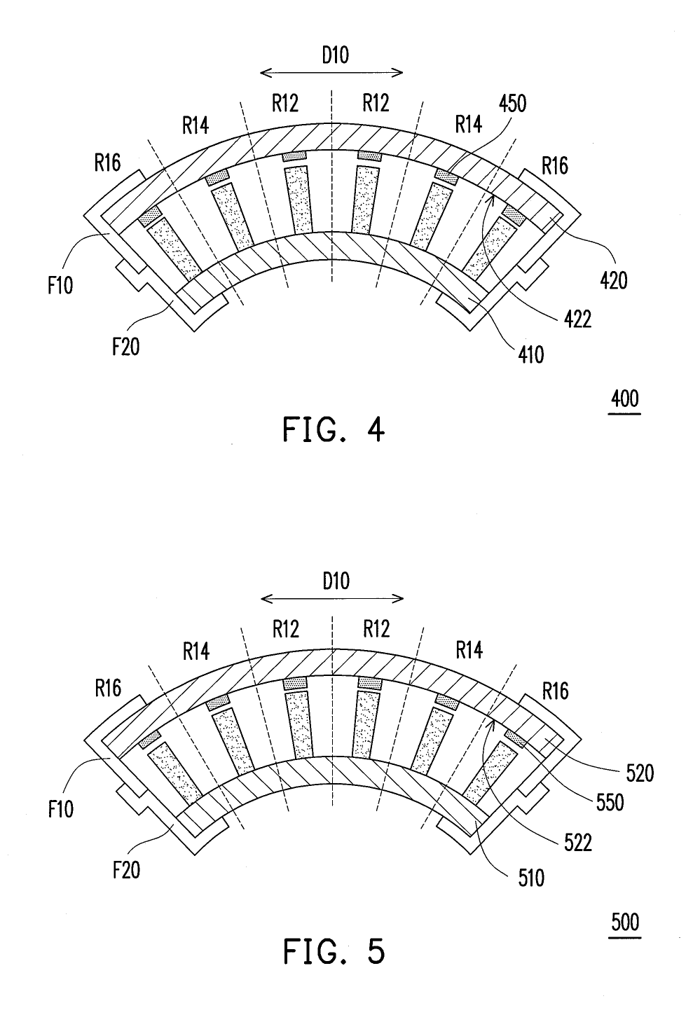

FIG. 4 is a schematic view illustrating a curved display panel according to another embodiment of the invention. With reference to FIG. 4, a curved display panel 400 of this embodiment is similar to the curved display panel 300 depicted in FIG. 3B, while the difference lies in that the first surface 422 of the second substrate 420 where the padding-islands 450 are disposed is a concave surface. In addition, the thicknesses of the padding-islands 450 on the different regions increase from the center of the second substrate 420 to the outside of the second substrate 420 along at least one direction D10. To be more specific, the thicknesses of the padding-islands 450 on the regions R12 are smaller than the thicknesses of the padding-islands 450 on the regions R14, and the thicknesses of the padding-islands 450 on the regions R14 are smaller than the thicknesses of the padding-islands 450 on the regions R16. The curved display panel 400 of this embodiment can be fixed by an upper iron frame F10 and a lower iron frame F20, and the first substrate 410 is bonded to the lower iron frame F20 by adhesive. Therefore, the lower iron frame F20 determines the bending degree of the first substrate 410, and the padding-islands 450 control the bending degree of the second substrate 420.

FIG. 5 is a schematic view illustrating a curved display panel according to still another embodiment of the invention. With reference to FIG. 5, a curved display panel 500 of this embodiment is similar to the curved display panel 400 depicted in FIG. 4, while the difference lies in that the thicknesses of the padding-islands 550 on the different regions decrease from the center of the second substrate 520 to the outside of the second substrate 520 along at least the direction D10. Specifically, the thicknesses of the padding-islands 550 on the regions R12 are greater than the thicknesses of the padding-islands 550 on the regions R14, and the thicknesses of the padding-islands 550 on the regions R14 are greater than the thicknesses of the padding-islands 550 on the regions R16. The curved display panel 500 of this embodiment can be fixed by an upper iron frame F10 and a lower iron frame F20, but neither the first substrate 510 nor the second substrate 520 is bonded to the upper and the lower iron frames F10 and F20 by adhesive. Therefore, the dimension of the lower iron frame F20 as a matter of course determines the bending degree of the first substrate 510, and the padding-islands 550 control the bending degree of the second substrate 520, so as to prevent the center of the second substrate 520 from being flattened.

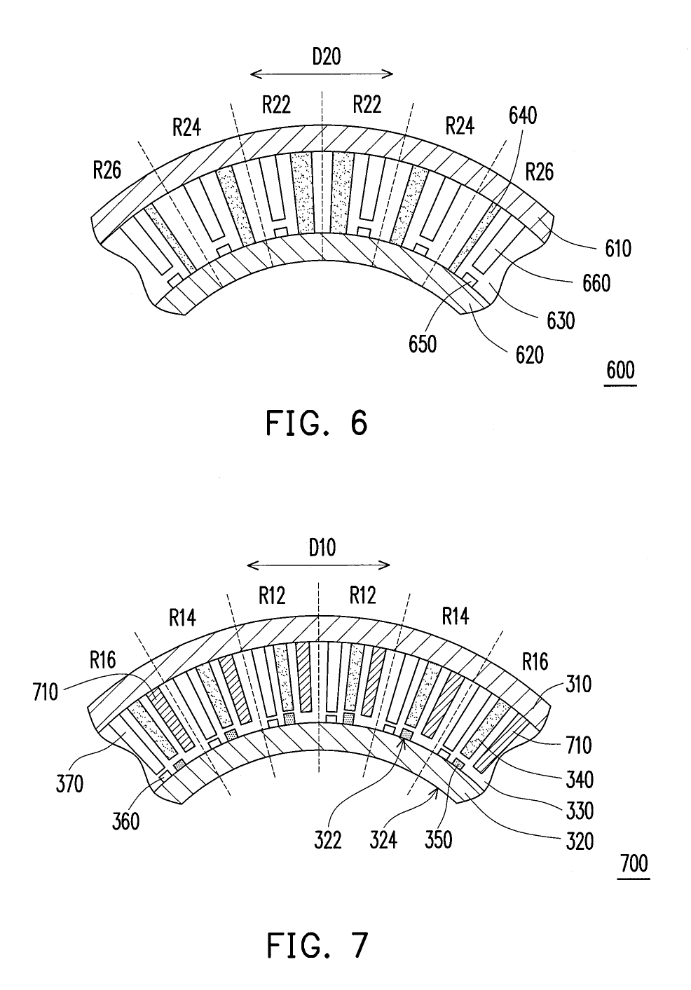

FIG. 6 is a schematic view illustrating a curved display panel according to still another embodiment of the invention. As shown in FIG. 6, a curved display panel 600 of this embodiment includes a first substrate 610, a second substrate 620, a display medium 630, and a plurality of first spacers 640. The display medium 630 and the first spacers 640 are disposed between the first and the second substrates 610 and 620. Bottom areas of the first spacers 640 decrease from the center of the second substrate 620 to the outside of the second substrate 620 along at least one direction D20. A cross-section of the second substrate 620 along the direction D20 is curved. The first substrate 610, the second substrate 620, and the display medium 630 in the curved display panel 600 are similar to those in the curved display panel 300 as depicted in FIG. 3B.

The first spacers 640 having the different bottom areas can provide the different regions with different supporting forces, so as to keep the distance between the first and the second substrates 610 and 620 constant. Thereby, the center of the second substrate 620 is not too close to the first substrate 610, so as to ensure that the distance between the first substrate 610 and the second substrate 620 remains constant. In case of uniformity of the distance between the first substrate 610 and the second substrate 620, display quality of the curved display panel 600 is optimized.

The curved display panel 600 of this embodiment further includes a plurality of sensing pads 650 and a plurality of sensing pillars 660. The sensing pads 650 are disposed on the second substrate 620, and the sensing pillars 660 are disposed on the first substrate 610 for correspondingly pressing the sensing pads 650. When a user presses the curved LCD panel 600, the sensing pillars 660 in the curved LCD panel 600 touch the sensing pads 650 in a downward manner, such that the sensing pads 650 are triggered to perform the touch-sensing function. Since the distance between the first and the second substrates 610 and 620 remains constant, the sensing pillars 660 do not constantly touch and trigger the sensing pads 650. As such, the curved LCD panel 600 is allowed to achieve the touch-sensing function. The sensing pads 650 can be pressure sensors or other types of sensing pads. Certainly, locations of the sensing pillars 660 and those of the sensing pads 650 can be exchanged. That is to say, the sensing pillars 660 are disposed on the second substrate 620, and the sensing pads 650 are disposed on the first substrate 610.

The second substrate 620 of this embodiment is an active device array substrate, and the first substrate 610 is a color filter substrate. In other embodiments, the second substrate 620 can be the color filter substrate, and the first substrate 610 can be the active device array substrate. In an alternative, the color filter film and the active device array can be formed on the same substrate.

The second substrate 620 of this embodiment is divided into a plurality of regions R22, R24, and R26, and the bottom areas of the first spacers 640 on the same regions are the same. When the curved display panel 600 is observed from the top of FIG. 6, the regions R22, R24, and R26 of the second substrate 620 can have a stripe shape, a grid shape, or any other shape. In this embodiment, each of the first spacers 640 is disposed in one of the regions R22, R24, and R26, for example. However, more first spacers 640 can be disposed in each of the regions R22, R24, and R26 according to other embodiments, and the thicknesses of the first spacers 640 in each of the regions R22, R24, and R26 can be the same, so as to simplify the manufacturing process of the curved display panel 600.

Additionally, in any two adjacent regions, the bottom areas of the first spacers 640 away from the center of the second substrate 620 are 70%-90% or 80%-85% of the bottom areas of the first spacers 640 near the center of the second substrate 620. Differences between the bottom areas of the first spacers 640 in any two adjacent regions decrease from the center of the second substrate 620 to the outside of the second substrate 620. The bottom areas of the first spacers 640 decrease in a linear manner or in a non-linear manner when a distance between the center of the second substrate 620 and the regions where the first spacers 640 are located increases. The bottom areas of the first spacers 640 on the different regions can decrease in a non-linear manner, e.g. 200, 180, 162, 144, . . . square micrometers, while the differences between the bottom areas of the first spacers 640 on adjacent regions decrease in a linear manner. Alternatively, the bottom areas of the first spacers 640 on the different regions can decrease in a non-linear manner, e.g. 200, 180, 162, 146, . . . square micrometers, and the differences between the bottom areas of the first spacers 640 on adjacent regions can decrease in a non-linear manner as well. The bottom areas of the first spacers 640 on the different regions can also decrease in a linear manner, e.g. 200, 180, 160, 140, . . . square micrometers.

FIG. 7 is a schematic view illustrating a curved display panel according to still another embodiment of the invention. With reference to FIG. 7, a curved display panel 700 of this embodiment is similar to the curved display panel 300 depicted in FIG. 3A, while the difference lies in that the curved display panel 700 further includes a plurality of second spacers 710 disposed between the first substrate 310 and the second substrate 320. The second spacers 740 assist in the first spacers 340 for maintaining a preferable distance between the first substrate 310 and the second substrate 320 when a relatively large force is applied to the curved display panel 700.

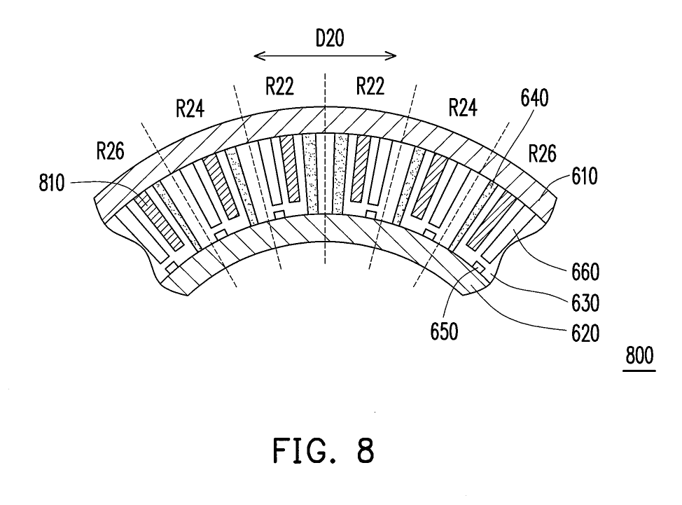

FIG. 8 is a schematic view illustrating a curved display panel according to still another embodiment of the invention. With reference to FIG. 8, a curved display panel 800 of this embodiment is similar to the curved display panel 600 depicted in FIG. 6, while the difference lies in that the curved display panel 800 further includes a plurality of second spacers 810 disposed between the first substrate 610 and the second substrate 620. The second spacers 810 assist in the first spacers 640 for maintaining a preferable distance between the first substrate 610 and the second substrate 620 when a relatively large force is applied to the curved display panel 800.

In light of the foregoing, the padding-islands in the curved display panel of this invention have different thicknesses when the locations of the padding-islands are changed, or the bottom areas of the spacing pillars are different when the locations of the spacing pillars are changed. As such, the bending degree of the substrates can be monitored for uniformizing the distance between the two substrates and improving the display quality. When the curved display panel is equipped with the touch-sensing function, the constant distance between the two substrates of the curved display panel in this invention is conducive to performing the touch-sensing function in a normal fashion.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A curved display panel comprising:
a first substrate;
a second substrate having a first surface and a second surface opposite to the first surface, the first surface facing toward the first substrate, the second surface facing against the first substrate;
a display medium disposed between the first substrate and the second substrate;
a plurality of first spacers disposed between the first substrate and the second substrate; and
a plurality of padding-islands disposed on a plurality of regions of the first surface of the second substrate, the padding-islands on the different regions having different thicknesses.

2. The curved display panel as claimed in claim 1, wherein when the second surface is a concave surface, the thicknesses of the padding-islands on the different regions decrease from a center of the second substrate to the outside of the second substrate along at least one first direction, and a cross-section of the second substrate along the at least one first direction is curved.

3. The curved display panel as claimed in claim 1, wherein when the first surface is a concave surface, the thicknesses of the padding-islands on the different regions increase from a center of the second substrate to the outside of the second substrate along at least one first direction.

4. The curved display panel as claimed in claim 1, wherein when the first surface is a concave surface, the thicknesses of the padding-islands on the different regions decrease from a center of the second substrate to the outside of the second substrate along at least one first direction.

5. The curved display panel as claimed in claim 1, further comprising a plurality of sensing pads and a plurality of sensing pillars, the sensing pads being disposed on the first surface of the second substrate, the sensing pillars being disposed on the first substrate for correspondingly pressing the sensing pads.

6. The curved display panel as claimed in claim 1, wherein a material of the padding-islands is an organic material.

7. The curved display panel as claimed in claim 1, wherein the second substrate is an active device array substrate.

8. The curved display panel as claimed in claim 1, wherein the first substrate is a color filter substrate.

9. The curved display panel as claimed in claim 1, wherein the padding-islands on the same regions have the same thicknesses.

10. The curved display panel as claimed in claim 1, further comprising a plurality of second spacers disposed between the first substrate and the second substrate.

11. A curved display panel comprising:
a first substrate;
a second substrate;
a display medium disposed between the first substrate and the second substrate; and
a plurality of first spacers disposed between the first substrate and the second substrate, bottom areas of the first spacers decreasing from a center of the second substrate to the outside of the second substrate along at least one first direction, a cross-section of the second substrate along the at least one first direction being curved.

12. The curved display panel as claimed in claim 11, further comprising a plurality of sensing pads and a plurality of sensing pillars, the sensing pads being disposed on the second substrate, the sensing pillars being disposed on the first substrate for correspondingly pressing the sensing pads.

13. The curved display panel as claimed in claim 11, wherein the second substrate is an active device array substrate.

14. The curved display panel as claimed in claim 11, wherein the first substrate is a color filter substrate.

15. The curved display panel as claimed in claim 11, wherein the second substrate is divided into a plurality of regions, and the bottom areas of the first spacers on the same regions are the same.

16. The curved display panel as claimed in claim 15, wherein the bottom areas of the first spacers away from the center of the second substrate are 70%˜90% of the bottom areas of the first spacers near the center of the second substrate in any two adjacent regions of the regions.

17. The curved display panel as claimed in claim 15, wherein the bottom areas of the first spacers away from the center of the second substrate are 80%˜85% of the bottom areas of the first spacers near the center of the second substrate in any two adjacent regions of the regions.

18. The curved display panel as claimed in claim 15, wherein differences between the bottom areas of the first spacers in any two adjacent regions of the regions decrease from the center of the second substrate to the outside of the second substrate.

19. The curved display panel as claimed in claim 15, wherein the bottom areas of the first spacers decrease in a linear manner when a distance between the center of the second substrate and the regions where the first spacers are located increases.

20. The curved display panel as claimed in claim 15, wherein the bottom areas of the first spacers decrease in a non-linear manner when a distance between the center of the second substrate and the regions where the first spacers are located increases.

21. The curved display panel as claimed in claim 11, wherein the bottom areas of the first spacers decrease in a linear manner when a distance between the center of the second substrate and the first spacers increases.

22. The curved display panel as claimed in claim 11, wherein the bottom areas of the first spacers decrease in a non-linear manner when a distance between the center of the second substrate and the first spacers increases.

23. The curved display panel as claimed in claim 11, further comprising a plurality of second spacers disposed between the first substrate and the second substrate.
